(19) United States
(12) Patent Application Publication
(10) Pub. No.: US 2009/0265994 A1
(43) Pub. Date: Oct. 29, 2009

(54) DOOR OPENING ASSISTING DEVICE

(75) Inventors: Ken Suzuki, Kanagawa (JP); Koichi Yamamuro, Kanagawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: NHK Spring Co., Ltd., Kanagawa (JP)

(21) Appl. No.: 12/093,324

(22) PCT Filed: Nov. 11, 2005
(86) PCT No.: PCT/JP2005/020751

§ 371 Date: May 10, 2008

(51) Int. Cl. E05F 11/54

(52) U.S. Cl. 49/358

(57) ABSTRACT

A door-opening assisting structure eliminates exclusive operating members and provides enhanced operability and reliability by operating in sync with the opening of a door. A passive member connected to a door closer, urges the door to move in the door-closing direction, rotates forward and backwards accompanying the opening and closing of the door. This moves transmission members forward and backwards in the direction of the opening and closing of the door, respectively. An opening spring urges the transmission member to move in the same in the direction as the opening of the door. The spring is locked in a release-pressure-storing state after accumulating release pressure as a result of the movement of the transmission member. The opening spring applies release pressure due to the rotation of the passive member within the predetermined angle region of the passive member when the door is beginning to open, and then is locked in the release-pressure-storing state.

### CROSS-REFERENCE TO RELATED APPLICATIONS

The present Application is based on International Application No. PCT/JP2005/020751, filed on Nov. 11, 2008, the disclosure of which is hereby incorporated by reference herein its entirety.

### FIELD OF THE INVENTION

This invention relates to a door-opening assisting device that assists the operating force used to open a door, thereby making door-opening easier.

### BACKGROUND OF THE INVENTION

Condominiums and buildings that have airtight construction require a large amount of force to open or close doors, and this imposes a large burden on children and elderly people. Therefore, door-opening assisting devices for assisting door opening have been used.

Existing door-opening assisting devices are generally provided separately from door closers and have a structure such that a power-magnifying mechanism for assisting door opening is mounted on a door or on a wall that supports the door, wherein rotating a knob or lever allows the power-magnifying mechanism to result in reduction of the force that a person must apply to open a door (see Patent Document 1).

Meanwhile, another door-closer mechanism is disclosed. The door-closer mechanism has

a door-closer drive mechanism that consists of a main spring, a main piston, a first driving member, and other parts, and
a door-opening assisting device that consists of a sub-spring, an assist piston, a second driving member, and other parts,
and wherein
the door-opening assisting device acts—at the time of door opening—against the door-closer drive mechanism, and
the door-closer drive mechanism and the door-opening assisting device are coupled together on the same longitudinal axis (see Patent Document 2).
Patent Document 1 U.S. Pat. No. 3,084,269
Patent Document 2 U.S. Pat. No. 3,229,782

### SUMMARY OF THE INVENTION

### Problems to be Solved by the Invention

The door-opening assisting device of Patent Document 1 is provided separately from the knob for opening and closing the door, and it is therefore necessary that an operating member, such as a dedicated knob, to operate a door-opening assisting device be installed separately. However, if such an operating member such as a dedicated knob is separate from the doorknob for door opening and closing, the operation becomes complicated, because it is necessary to operate the knob dedicated for the door-opening assisting device in addition to operating the door's usual knob itself.

Furthermore, in such a case, not only is the door-opening assisting device conspicuous, because the door-opening assisting device is separate from the door's usual knob, but also the appearance of the door is impaired because the number of parts mounted on the door is increased.

The closer of Patent Document 2 has certainly solved the problems of the above-mentioned Patent Document 1. However, with the closer of Patent Document 2, when the door-opening operation is underway, the door-opening assisting device that is directly coupled to the door-closer mechanism (1) detects the rotation angle of the main spindle through an encoder mounted on the main spindle, then (2) in response to the instruction of a control section that receives a signal—emitted from the encoder—that indicates the detected rotation angle of the main spindle, rotates a second drive member that consists of a motor, gears, an auxiliary axis, a pinion, and the like, so as to move the assist piston in the door-closing direction. Accordingly, such a mechanism results in a heavy and expensive device that requires complicated construction and a control system. Moreover, the device requires a separate power source, which has such shortcomings that, in the case of a power shutdown or power failure, the door-opening assisting device does not operate and instead works in an inhibitive manner as a resisting force in the direction opposite to door opening and closing. In addition, control is required to keep rotating the second drive member of said door-opening assisting mechanism and to maintain the operation to move the assist piston in the direction indicated by door closing, both of which are cumbersome.

The present invention was made in view of the existing problems, and one objective of the present invention is to provide a door-opening assisting device that (1) not only eliminates the need for operating members (except an ordinary doorknob), for an expensive electromagnetic control system, and for an electric drive mechanism, (2) increases the reliability of the total door-closing operation by operating in sync with the opening of the door, which therefore enhances the ease of opening and closing the door and (3) makes the device compact and less conspicuous, preventing deterioration of the door's appearance.

### Means of Solving the Problems

In order to achieve the above-mentioned objective, the door-opening assisting device according to Claim 1 provides a structure such that

a passive member that is connected to a door closer that urges the door to move in the closing direction and that rotates forward and backwards in response to the opening and closing, respectively, of the door,
these rotations cause the transmission members to move forward and backwards in the direction indicated by opening and closing, respectively, of the door, and
an opening spring urges said transmission members to move the same in the direction indicated by opening accompanying the door opening, and is locked in a release-pressure-storing state after accumulating and storing the release pressure that results from the movement of the transmission members,
and wherein
as a result of the rotation of the passive member within the predetermined angle region when the door is beginning to open, said opening spring applies the release pressure and then is locked in the release-pressure-storing state after storing release pressure.

The door-opening assisting device according to Claim 2 includes

a passive member that is connected to a door closer that urges the door to move in the door-closing direction, and that rotates forward and backwards in response to the opening and closing, respectively, of the door,
a transmission member that moves forward and backwards in the direction indicated by the opening and closing, respectively, of the door when said transmission member is connected with the passive member,
an opening spring that urges said transmission member to move the same in the door-opening direction accompanying the door opening, and that accumulates and then stores door-opening release pressure as a result of the movement of the transmission member,
a lock mechanism that locks the opening spring in the release-pressure-storing state when the door opens, and
an unlocking member that unlocks the lock mechanism in response to the closing of the door,
and wherein
said passive member has a connecting portion on a part of said passive member's outer surface, and
said connecting portion connects with the transmission member in such a way that the opening spring is caused to apply release pressure due to the rotation of the passive member within the predetermined angle region when the door is beginning to open, to continuously accumulate and store release pressure, and to be locked in the release-pressure-storing state.

The door-opening assisting device according to Claim 3 includes

a passive member that is connected to a door closer that urges the door to move in the door-closing direction, and that rotates forward and backwards in response to the opening and closing, respectively, of the door,
a transmission member that, when connected with the passive member, moves forward and backwards in the direction indicated by the opening and closing, respectively, of the door,
an opening spring that urges said transmission member to move the same in the door-opening direction accompanying the door opening, and that accumulates and stores door-opening release pressure as a result of the movement of the transmission member,
a fixing member that, in order to remain fixed at a home position, stretches in the direction indicated by the movement of the transmission member,
a workpiece that is provided between the opening spring and the transmission member in such a way that it can receive the opening spring's moving force and to move along
the fixing member, applying moving force received from the transmission member,
a lock mechanism that is supported by the fixing member and that has lock balls that, as a result of the opening of the door, lock the movement of the workpiece and thus lock the opening spring in the release-pressure-storing state, and
an unlocking member that, as a result of the closing of the door, unlocks the workpiece,
and wherein
said passive member has a connecting portion on its outer surface, and
said connecting portion of the passive member connects with the transmission member in such a way that the opening spring is caused to apply release pressure as a result of the rotation of the passive member within the predetermined angle region when the door is beginning to open, to continuously accumulate and store release pressure, and to be locked in the release-pressure-storing state.

The door-opening assisting device according to Claim 4 includes

a passive member that is connected to a door closer that urges the door to move in the door-closing direction, and that rotates forward and backwards in response to the opening and closing, respectively, of the door,
a transmission member that can contact the passive member and that moves forward and backwards in the door-opening direction and door-closing direction, respectively,
an opening spring that urges said transmission member to move the same in the door-opening direction accompanying the door opening, and that, as a result of the movement of the transmission member, accumulates and stores door-opening release pressure,
a lock mechanism that, when the door opens, locks the opening spring in the release-pressure-storing state, and
an unlocking member that, due to the closing of the door, unlocks the lock mechanism,
and wherein
said passive member has a cam face that contacts the transmission member, and
said cam face is formed so as to allow the opening spring to apply release pressure due to the rotation of the passive member within the area of the predetermined angle at the beginning of door opening, and so as to allow the opening spring to accumulate and store release pressure and to be locked in the release-pressure-storing state.

The door-opening assisting device according to Claim 5 includes

a passive member that is connected to a door closer that urges the door to move in the door-closing direction, and that rotates forward and backwards as a result of the opening and closing, respectively, of the door,
a transmission member that can contact the passive member and that moves forward and backwards in the door-opening direction and door-closing direction, respectively,
an opening spring that urges said transmission member to move the same in the door-opening direction accompanying the door opening, and that, as a result of the movement of the transmission member, accumulates and stores door-opening release pressure,
a fixing member that, in order to remain fixed at a home position, stretches in the direction indicated by the movement of the transmission member,
a workpiece that is provided between the opening spring and the transmission member in such a way that it can receive the opening spring's urging force and move along the fixing member, applying urging force received from the transmission member,
a lock mechanism that is supported by the fixing member and that has lock balls that, as a result of the opening of the door, lock the movement of the workpiece and thus locks the opening spring in the release-pressure-storing state, and
an unlocking member that, due to the closing of the door, unlocks the workpiece,
and wherein
said passive member has a cam face that contacts the transmission member, and
said cam face is formed so as to allow the opening spring to apply release pressure due to the rotation of the passive member within the area of the predetermined angle at the beginning of door opening, and so as to allow the opening spring to accumulate and store release pressure and to be locked in the release-pressure-storing state.

The invention according to Claim 6 is a door-opening assisting device as described in any one of Claims 2 to 5, and wherein

there is provided between said lock mechanism and said unlocking member an unlock-delaying mechanism that, in a delayed manner after said door is totally closed, unlocks the workpiece.

The invention according to Claim 7 is a door-opening assisting device as described in Claim 6, and wherein

said unlock-delaying mechanism includes at least
a lock spring that urges said unlocking member in the locking direction,
an unlock spring that urges the unlocking member in the direction opposite to the direction to which the lock spring urges said unlocking member, and
a damper mechanism that is mounted on one side of the unlocking member, and that slows the back and forth movement of the unlocking member.

The invention according to Claim 8 is the door-opening assisting device as described in Claim 7, and wherein

said damper mechanism includes
a cylindrical cavity that extends along one side of the unlocking member and that contains oil,
a piston that is mounted on one side of the unlocking member, and is inserted into said cavity and slides along the inner wall of said cavity, and
a narrow channel that links the inside of said cavity and the piston.

The invention according to Claim 9 is the door-opening assisting device as described in Claim 2 or Claim 3, and wherein

said transmission member is provided in pairs in a way that can independently move forward and backwards, and
each of the connecting portions of said passive member is formed separately in a way that enables it to connect with its corresponding transmission member.

The invention according to Claim 10 is the door-opening assisting device as described in Claim 2 or Claim 3, and wherein

said passive member is a pinion gear, and
said transmission member is a rack.

The invention according to Claim 11 is the door-opening assisting device as described in Claim 4 or Claim 5, and wherein

said transmission member includes a first transmission member and a second transmission member that independently move forward and backwards, and
said cam face includes a first cam face that receives the movement of the first transmission member that moves back to the state when the door begins to open, caused by the release pressure of the opening spring, and a second cam face that moves the second transmission member in the direction where the opening spring accumulates and stores release pressure when the door begins to open in succession of the movement of the first transmission member.

The invention according to Claim 12 is the door-opening assisting device as described in Claim 11, and wherein

a return spring urges said second transmission member to contact the second cam face.

### EFFECTS OF THE INVENTION

According to the invention of Claim 1, the opening spring applies release pressure when the door begins to open, resulting in reduction of the operating force needed to open the door when the door begins to open. Moreover, because the opening spring stores the release pressure and is locked in a release-pressure-storing state when the door begins to open, the opening spring can store opening torque during the period from when the door begins to open to when the door is open enough to allow a person to pass through the doorway. Therefore, the operating force necessary for the next door-opening operation is reduced, without requiring full opening of the door. Accordingly, operability is further enhanced. In addition, the door-opening assisting device has no need for operating members other than an ordinary doorknob, which makes the device less conspicuous and avoids degradation in the door's appearance.

With the invention of Claim 2, by the movement of the door within the predetermined angle region when the door begins to open—i.e., the movement of the door as it opens to the extent just before it is open enough to allow a person to pass through the doorway—the opening spring successively applies release pressure and then accumulates and stores release pressure, and the transmission member moves as it connects with the connecting portion of the passive member, as a result of which the opening spring is locked in a release-pressure-storing state. After the release pressure is stored, it is possible to arrange the door-opening assisting device in such a way that resistance cannot be applied even if the door is moved in the opening direction, and the force of the door closer is not reduced in the door-closing direction After that, an unlocking mechanism opens the lock in response to the closing of the door. That is to say, a series of operations that successively applies the release pressure in the door-opening direction until the door moves to the predetermined angle and that then accumulates and stores release pressure in accordance with successive movement of the opening of the door before the door is opened enough for a person to be able to pass through the doorway. Therefore, for example, even when the door starts to open but then closes before it opens fully, such malfunction as failing to store the force that when applied urges the passive member to rotate, i.e., the door-opening torque, will not take place as a result of the opening spring applying release pressure to the transmission member. This allows the door to be urged in the opening direction when the door is closing and reduces the operating force needed to open the door, and to operate just by reversing the locking of the door, resulting in improved operability. Furthermore, the door-opening assisting device becomes less conspicuous, eliminating operating members other than an ordinary doorknob, and preventing the degradation of the appearance of the door.

Also according to the present invention, because the transmission member connects with the passive member that is rotating in sync with the rotation of the pinion of the door closer, the door-opening assisting device can be installed onto the door closer as one integrated piece, making the whole arrangement, including the door closer mounted on the upper part of the door, compact in size, so as both to improve the exterior appearance and not to hinder the passage of people through the doorway.

Furthermore, the door-opening assisting device can easily later be mounted on the standard door closer, such as by installing only a passive member and a case.

With the invention of Claim 3, in a manner similar to that of the invention of Claim 2, due to the movement of the door within the predetermined angle region when the door begins to open, the opening spring successively applies release pressure and then accumulates and stores release pressure, and the transmission member moves as it connects with the connecting portion of the passive member, as a result of which the opening spring gets locked in the release-pressure-storing state. This allows the opening spring to unfailingly accumulate and store release pressure just by the door being opened to the extent just less than the extent necessary to allow a person to pass through the doorway, and after the opening spring stores the release pressure, it can prevent resistance from being added if the door is moved in the opening direction. After that, in response to the closing of the door, the unlocking mechanism reverses the locking by the lock balls. Accordingly, this invention also obtains the same result as the invention of Claim 2.

With the inventions of Claim 4 and Claim 5, the cam face formed on the passive member allows the opening spring to apply the release pressure due to the rotation of the passive member within the predetermined angle region when the door begins to open, and because the opening spring stores the release pressure and is locked in the release-pressure-storing state, the opening spring can store door-opening torque during the period from when the door begins to open to when the door is opened to the extent that allows a person to pass through the doorway. Accordingly, operability is enhanced, because the operating force needed to open the door the next time is reduced, without requiring full opening of the door and making the door-opening assisting device less conspicuous by eliminating the need for operating members other than an ordinary doorknob, which in turn prevents the degradation of the appearance of the door.

The invention of Claim 6 has, in addition to the features of the inventions of Claims 1 to 5, an unlock-delaying mechanism that, in a delayed manner after the door is totally closed, unlocks the workpiece, and then the release pressure for opening the door is applied after the door is closed and is locked completely. Accordingly, the locking is effected unfailingly, because release pressure is not applied to the door until the door is totally closed, resulting in improving the reliability of the door-opening and door-closing operation.

With the invention of Claim 7, which achieves results similar to the invention of Claim 6, the door-opening assisting device urges the unlocking member—by the unlock spring—in the direction opposite to the direction urged by the lock spring, and the damper mechanism slows the movement of the unlocking member. Such unlock-delaying mechanism can unlock the workpiece in a delayed manner after the door is totally closed. Accordingly, locking is effected unfailingly, because release pressure is not applied to the door until the door is totally closed, resulting in improved reliability of the door-opening and door-closing operations.

With the invention of Claim 8, which achieves results similar to the invention of Claim 7, the damper mechanism includes an unlocking member piston, a cylindrical cavity that holds oil and the piston that has been inserted into it and that is sliding within it, and a narrow channel that links the piston and the cylindrical cavity. This makes the movement of the unlocking member smoother and facilitates easier setting and adjusting of both the viscosity of the oil and the cross-section area of the narrow channel, and also further improves the reliability of operation of the unlock-delaying mechanism that slows the movement of the unlocking member.

Because the invention of Claim 9, which has results similar to the inventions of Claims 2 and 3, arranges the transmission member in pairs, the movement of the transmission member, the smooth application of the release pressure and the smooth operation of storing release pressure of the opening spring as a result of the movement of the transmission member are secured.

With the invention of Claim 10, which has results similar to the inventions of Claims 2 and 3, the passive member is a pinion gear and the transmission member is a rack, and as a result the door-opening assisting device is simple, compact, and has high reliability of power transmission.

With the invention of Claim 11, which has results similar to the inventions of Claims 4 and 5, because the first cam face receives the movement of the first transmission member when the door begins to open as a result of the release pressure of the opening spring and then, following the movement of the first transmission member, the second cam face then moves the second transmission member in the direction where the opening spring accumulates and stores release pressure when the door begins to open in succession of the movement of the first transmission member, so that the smooth application of the release pressure and the smooth operation of storing release pressure of the opening spring as a result of the movement of the transmission member are secured.

With the invention of Claim 12, which has results similar to the invention of Claim 11, because the return spring urges the second transmission member so as to contact the second cam face, the second cam face and the second transmission member unfailingly contact each other, further increasing the reliability of operation.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTIONS OF THE DRAWINGS

The present invention is illustrated by way of example, and not by limitation, in the figures of the accompanying drawings, wherein elements having the same reference numeral designations represent like elements throughout and wherein:

FIG. 1 is a front view of a door provided with a door-opening assisting device according to the first embodiment of the present invention, as seen from the inside of the room.

FIG. 2 is a side view of the door shown in FIG. 1.

FIG. 3 is a plan view of FIG. 1.

FIG. 4 is a cross-sectional view along the line A-A of FIG. 2.

FIG. 5 is a cross-sectional view along arrow B of FIG. 4.

FIG. 6 is a cross-sectional view along arrow C of FIG. 4.

FIG. 7 is a cross-sectional view along the line D-D of FIG. 6.

FIG. 8 is an enlarged view of area E of FIG. 7.

FIG. 9 is a cross-sectional view showing the condition when the door-opening assisting device directs and energizes a door in the door-opening direction when the door is totally closed.

FIG. 10 is a cross-sectional view showing the condition when a door is opened, from the totally closed condition, within the area where the door-opening assisting device assists to open the door.

FIG. 11 is a cross-sectional view showing the condition when the opening spring starts to accumulate and store the release pressure in the state where the door is opened to the finishing position of the area where the door-opening assisting device assists to open the door.

FIG. 12 is a cross-sectional view showing the condition after the opening spring has completed storing the release pressure.

In FIG. 13, (a) is a cross-sectional view showing the locked state after the opening spring has completed storing the release pressure; (b) is a view showing the condition when a first transmission member is connected with one of the portion gears of a passive member; and (c) is a view showing the condition when a second transmission member is connected with another portion gear of a passive member.

In FIG. 14, (a) is a cross-sectional view showing the condition when the door is opened further than in the condition shown in FIG. 13; (b) is a view showing the condition when the first transmission member has been disengaged from the portion gear of a passive member; and (c) is a view showing the condition when disengagement the second transmission member has been disengaged from the other portion gear of a passive member in the condition of (b).

FIG. 15 is a cross-sectional view showing the condition when the door is almost totally closed.

FIG. 16 is a cross-sectional view showing the condition when the door is at the moment of being totally closed, which is just prior to when the lock of a lock mechanism starts to be unlocked.

FIG. 17 is a cross-sectional view showing the condition when the lock of the lock mechanism is unlocked in a delayed manner after the door is totally closed.

FIG. 18 is a cross-sectional view of the second embodiment of the present invention.

FIG. 19 is a cross-sectional view along the line H-H of FIG. 18.

FIG. 20 is a cross-sectional view along the line I-I of FIG. 18.

FIG. 21 is a cross-sectional view along the line C-C of FIG. 19.

FIG. 22 is a cross-sectional view along the line K-K of FIG. 19.

FIG. 23 is a cross-sectional view along the line L-L of FIG. 19.

### EXPLANATIONS OF ALPHANUMERIC CHARACTERS

1, 1A Door-opening assisting device
2 Door
4 Door closer
9 Pinion
10 Case
20 Passive member
20b, 20c Portion gear
30 First transmission member
31 Second transmission member
40 Guide cylinder (fixing member)
43 Unlock spring
44 Unlocking member
44a Piston
44e Orifice (narrow channel)
45 Lock spring
46 Lock ball
50 Workpiece
51 Opening spring
201 First cam face
202 Second cam face

### BEST MODES FOR CARRYING OUT THE INVENTION

The embodiments of the present invention will now be explained with reference to the drawings.

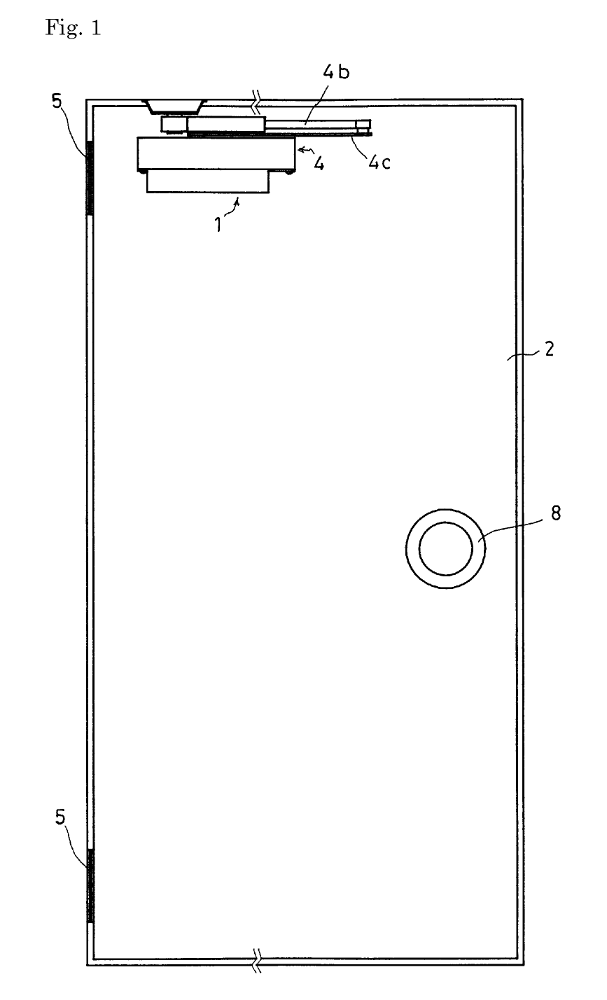

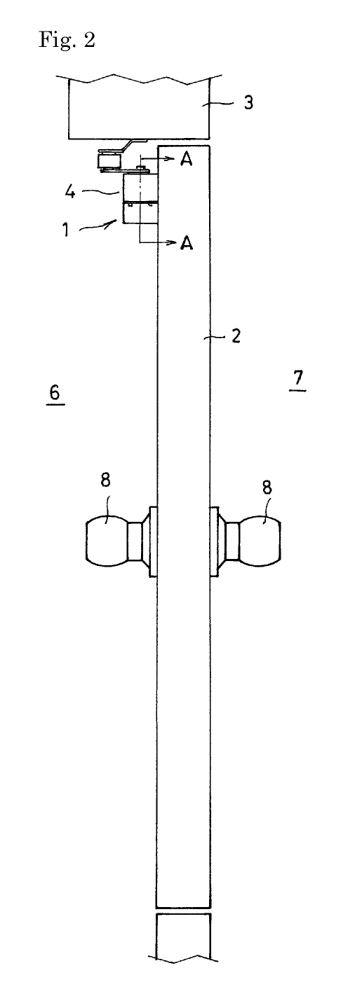

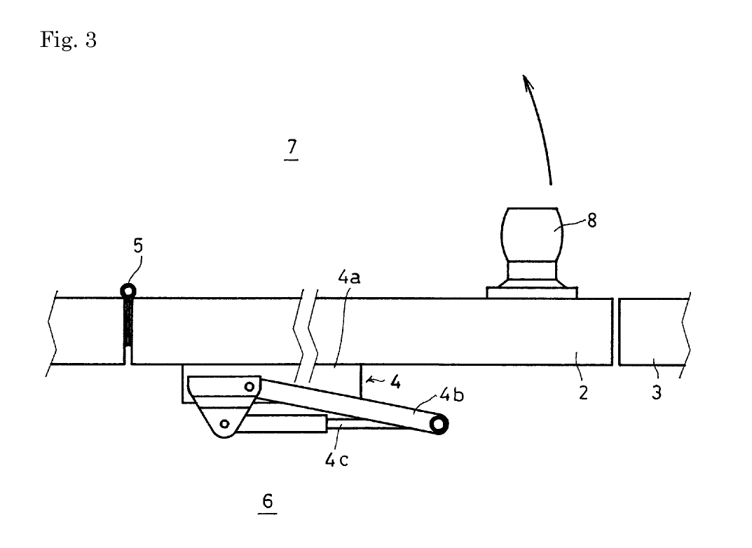

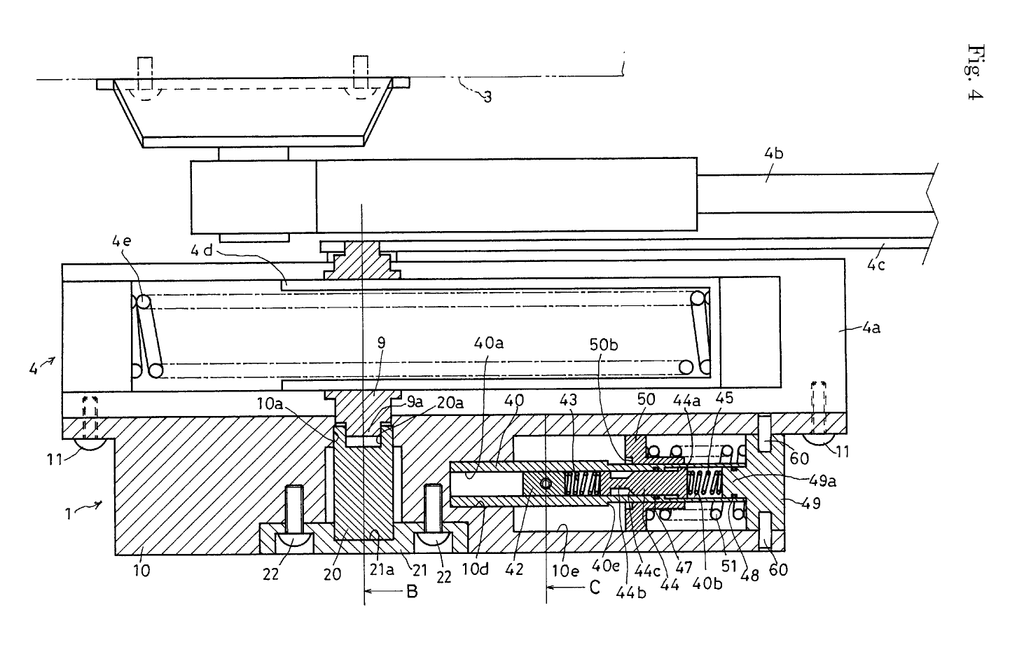

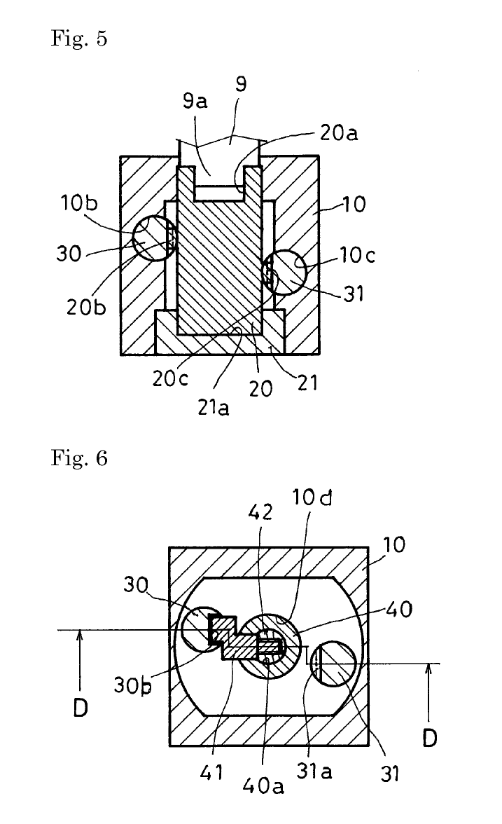

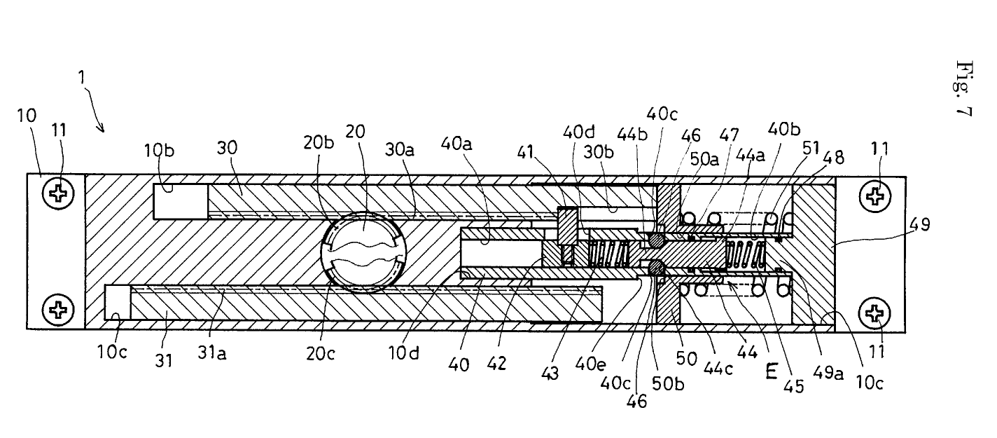

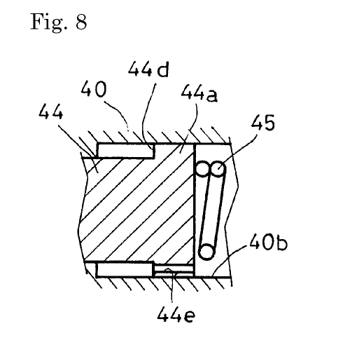

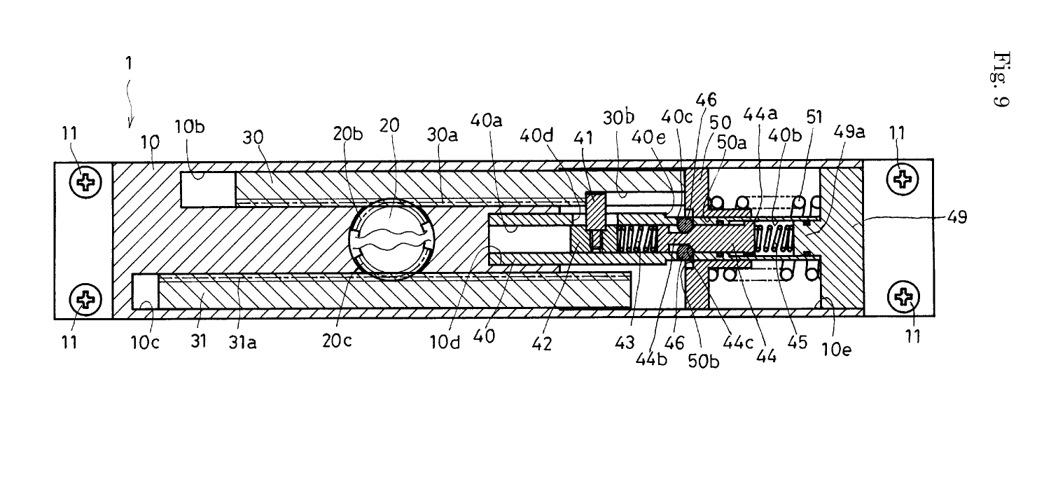

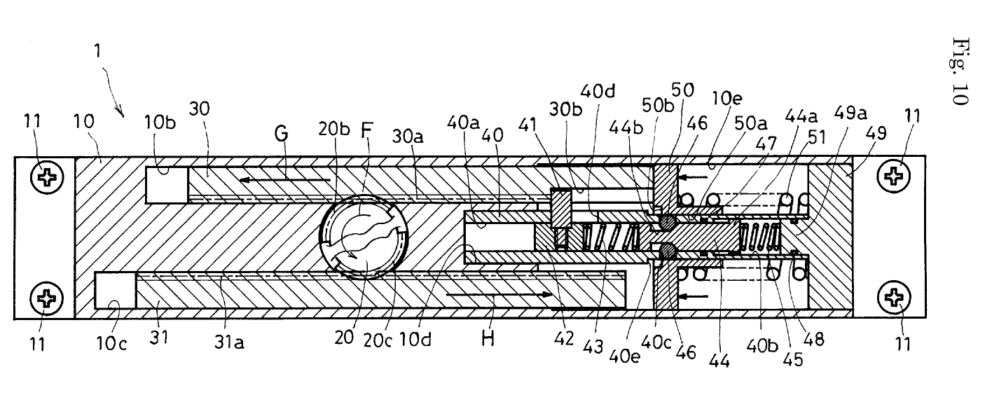

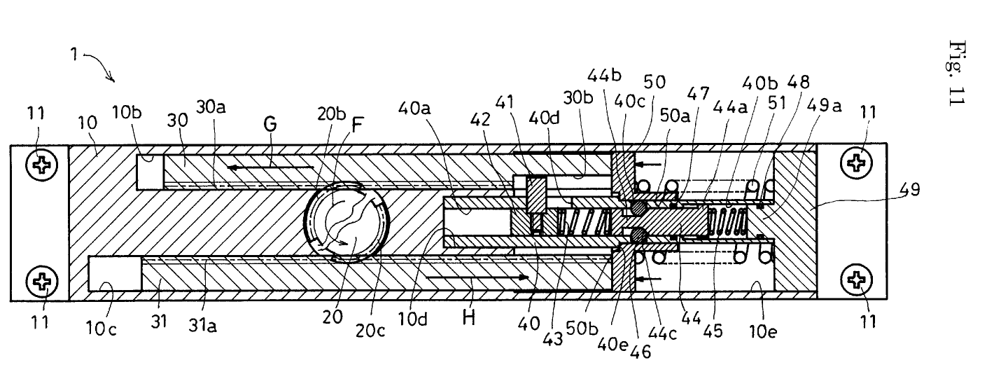

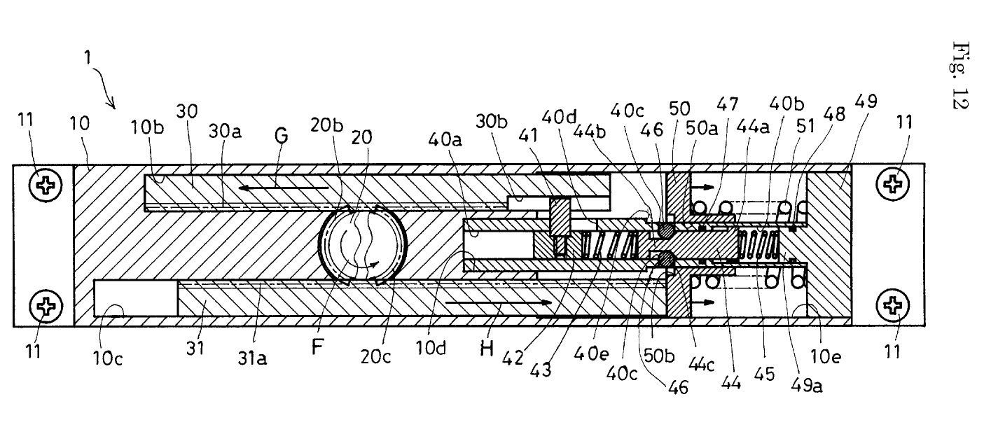

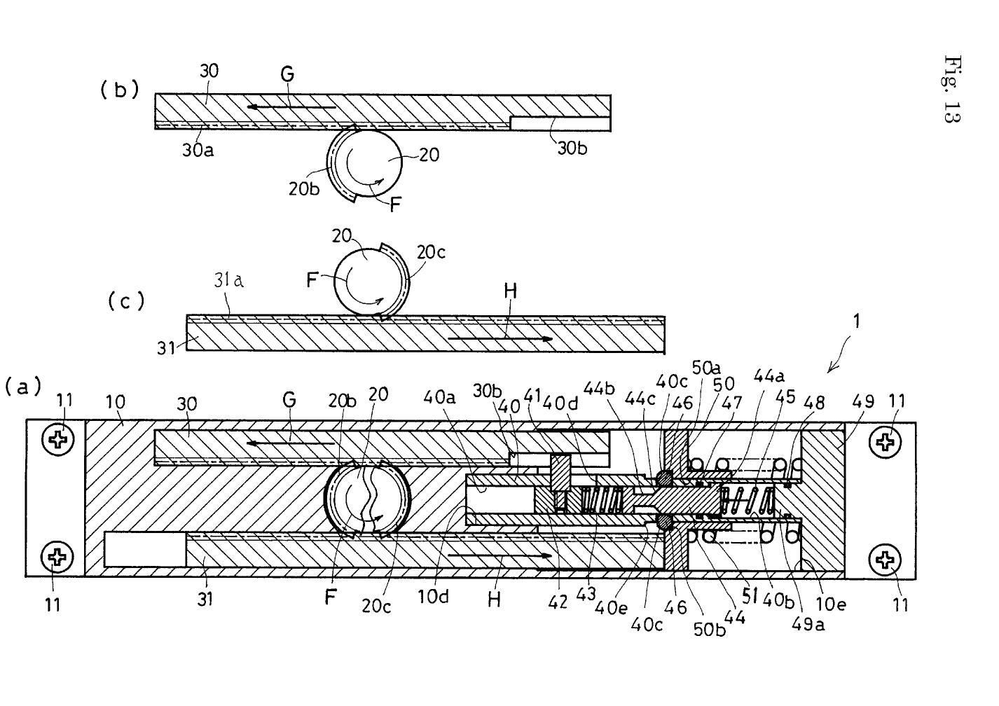

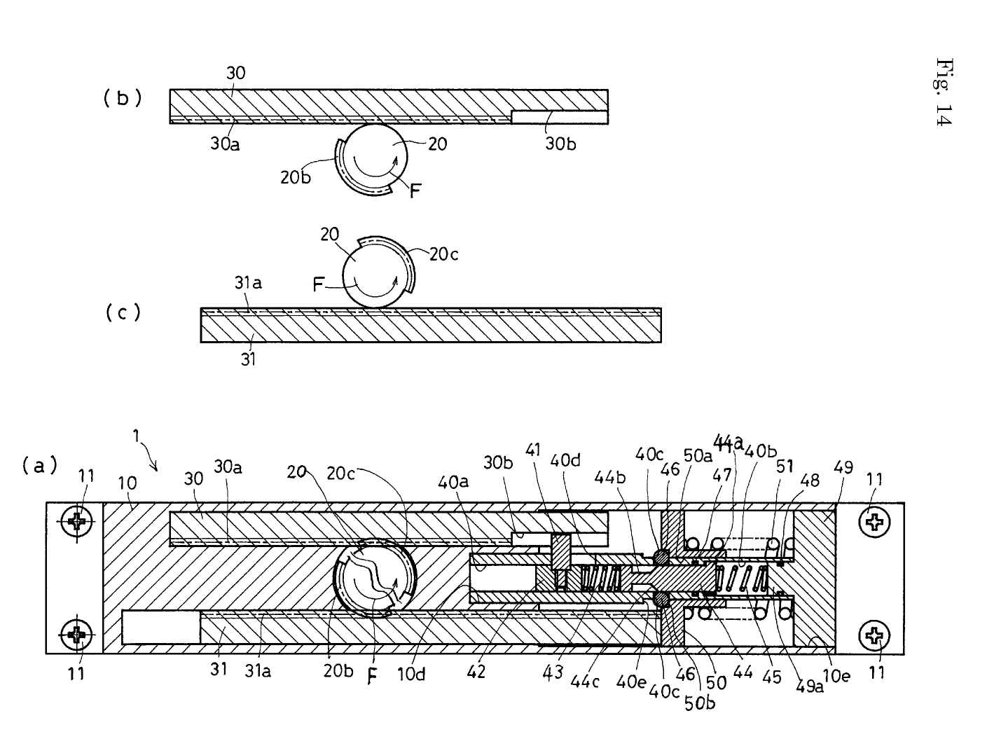

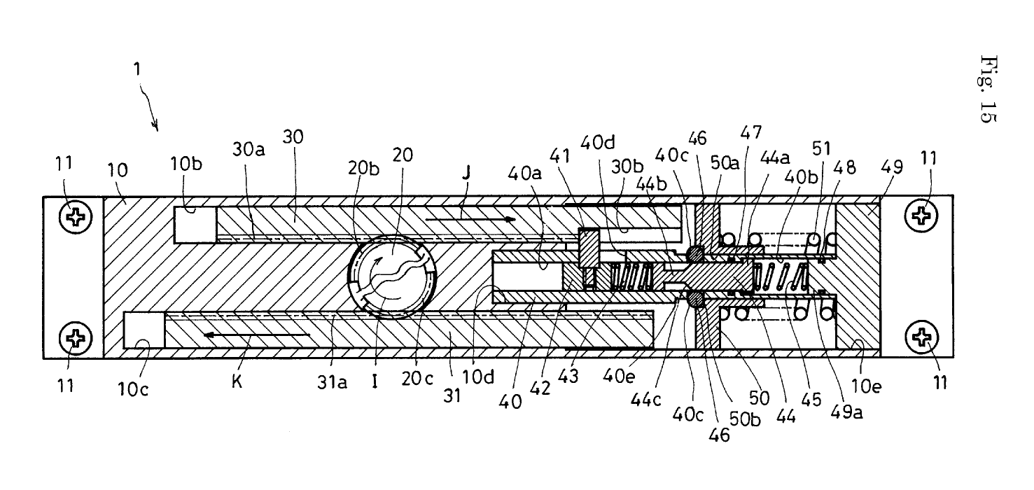

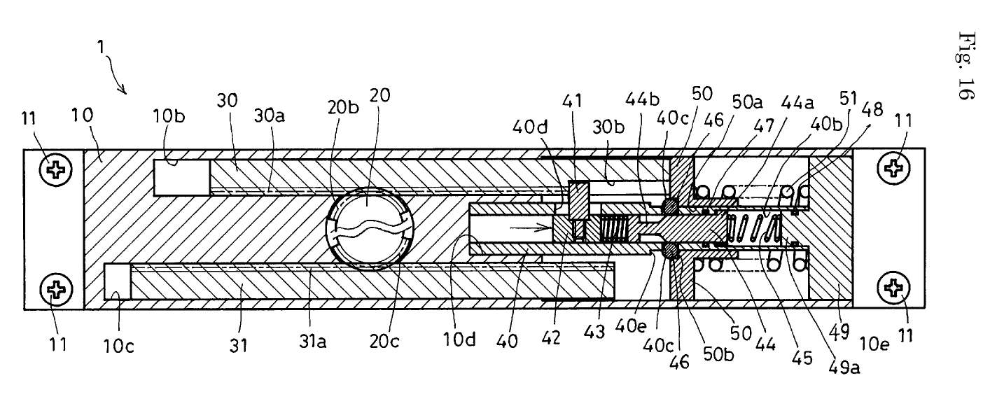

FIGS. 1 to 17 show the construction and operating condition of a door-opening assisting device according to a first embodiment. FIG. 1 is a front view of a door that has a door-opening assisting device, as seen from inside of a room. FIG. 2 is a side view of the door. FIG. 3 is a plan view of the door. FIG. 4 is a cross-sectional view along the line A-A of FIG. 2. FIG. 5 is a cross-sectional view along arrow B of FIG. 4. FIG. 6 is a cross-sectional view along arrow C of FIG. 4. FIG. 7 is a cross-sectional view along the line D-D of FIG. 6. FIG. 8 is an enlarged view of portion E of FIG. 7. FIGS. 9 to 17 are views showing the condition of the door-opening assisting device while it is in operation.

A door-opening assisting device 1 according to this embodiment is mounted on the underside of a door closer 4 that is mounted on a door 2 and on a wall 3 that supports the door 2 in a manner that allows the door 2 to open and close, as shown in FIGS. 1 to 3. The door 2 is supported on the wall 3 in a way such that the door can move forward and backwards via a hinge 5, with the door opening and closing as a result of such forward and backwards movements. Knobs 8 are attached on each side of the door 2, inside the room 6 and outside the room 7. The turning of a knob 8 causes a latch (not shown) to extend through the wall 3 to reverse the locking of the door, allowing the door to be opened.

This embodiment of the door-opening assisting device 1 operates under the condition of being mounted on a commonly used door closer 4, so that the door-opening assisting device 1 directs and energizes the door 2 to rotate in the direction indicated by opening. The door closer 4 is described below, referring to FIG. 4.

The door closer 4 is provided with (1) a box-shaped closer unit 4a that is affixed on the door 2, and (2) two arms 4b and 4c that are pivotally supported on the closer unit 4a and the wall 3, respectively, while also being connected in their middle part in the pivoted condition. Inside the closer unit 4a, a piston 4d that moves back and forth, and a coil spring 4e that urges the piston 4d to move so as to close the door 2 are placed. A pinion 9 is attached to the closer unit 4a in such a way that its axial end penetrates in the thickness direction of the closer unit 4a, and the pinion 9 connects with a transmission member (not shown) on the piston 4d. Therefore, when the piston 4d moves back and forth in accordance with the opening and closing of the door 2, the pinion 9 rotates forward and backwards. When the door 2 begins to open due to the turning of the knob 8 and so on, the piston 4d moves so as to compress the coil spring 4e, and release pressure is accordingly stored in said coil spring 4e in the door-closing direction. As a result, the door closer 4 operates such that the door 2 closes automatically.

The axial end 9a of the pinion 9 is shaped so as to have a noncircular cross-section, such as a rectangular cross-section, and part of the pinion extends out from the closer unit 4a. The door-opening assisting device 1 is used in connection with the axial end 9a of the pinion 9 that extends out from the closer unit 4a.

This embodiment of the door-opening assisting device 1 is provided with a passive member 20, a pair of transmission members 30 and 31, opening spring 51 that stores torque in the door-opening direction, a workpiece 50, a lock mechanism that includes lock balls 46, an unlocking mechanism that includes an unlocking member 44, and a case 10 that houses the above-mentioned mechanisms and members.

The top end of the passive member 20 is inserted into an opening 10a that is formed on the upper part of the case 10, and the lower end of the passive member 20 is inserted into a recess 21a that is formed on a cover 21 in a way such that each end can rotate freely, as shown in FIGS. 4 and 5. A fitting hole 20a, which has a noncircular cross-section such as rectangular cross-section corresponding to the external shape of the axial end 9a of the pinion 9 that extends out from the closer unit 4a, is formed at the top end of the passive member 20. By inserting the axial end 9a of the pinion 9 into the fitting hole 20a, the passive member 20 is connected to the pinion 9 coaxially and rotates in sync with the rotation of the pinion 9. A cover 21 is affixed under the surface of the case 10 by a screw 22 in a way such that the cover 21 prevents the passive member 20 from falling off down.

The case 10 is mounted on the door closer 4, contacting the closer unit 4a of the door closer 4 in such a way that the passive member 20 is connected to the pinion 9 of the door closer 4 and is affixed by a screw 11. Therefore, the door-opening assisting device 1 is provided on the door 2 coupled with the door closer 4.

As shown in FIGS. 5 to 7, a pair of transmission members 30 and 31 are received slidably in a pair of holes 10b and 10c, respectively, that are formed so as to be provided in parallel in the longitudinal direction of the case 10 and so as to be positioned at the opposite sides of the passive member 20. Connecting portions 30a and 31a are formed, respectively, on the sides of the passive member 20 of the pair of transmission members 30 and 31, and these connecting portions 30a and 31a connect with the passive member 20. Here, the passive member 20 can be a pinion gear, and the transmission members 30 and 31 can be a rack. Accordingly, there can be made a simple and compact door-opening assisting device that has high power-transmission reliability between the passive member 20 and the transmission members 30 and 31.

The passive member 20 consists of a pair of portion gears 20b and 20c that are spaced apart and positioned against and connected with connecting portions 30a and 31a of a pair of transmission members 30 and 31, respectively, and that are formed partially (as, for example, approximately a semicircle) on the outer face of the passive member 20 within a predetermined angle region. Detailed reasons as to why the portion gears 20b and 20c are formed that way will be presented later. In brief, the reasons are: (1) The movement of the transmission member 30 accompanying the connection of the portion gear 20b of the passive member 20 with the connecting portion 30a of the transmission member 30 allows the opening spring 51 to finish applying release pressure by rotating halfway within the predetermined angle region when the door begins to open; (2) The movement of the transmission member 31 accompanying the connection of the portion gear 20c of the passive member 20 with the connecting portion 30a of the transmission member 31 by subsequent rotation within the entire predetermined angle region allows the opening spring 51 to accumulate and store release pressure; and (3) The lock balls 46 lock the movement of the workpiece 50 as soon as storing of release pressure is completed.

Accordingly, while the rotation of the passive member 20 allows the transmission members 30 and 31 to move forward and backwards relatively in the rectilinear direction, the relative movement of the transmission members 30 and 31 in the rectilinear direction rotates the passive member 20. When parts need to be identified hereinafter, the transmission member positioned in the upper part of the Figures will be referred to as the first transmission member 30 and the transmission member positioned in the lower part of the Figures will be referred to as the second transmission member 31.

For the case 10, a cavity 10e that has a noncircular cross-section is formed from one side to the other side. In the central part of the internal surface at the end of the cavity 10e, a recess 10d is further formed. A block 49 is inserted into the open end of the cavity 10e and is affixed by, for example, pins 60.

A guide cylinder 40 is affixed such that it integrally extends from one side (shown on the left in the Figures) within the central part of the cavity 10e of the case 10 to the other side (shown on the right in the Figures), and one end of said guide cylinder 40 is inserted on a bump 49a that is formed on the inner surface of the lock 49, while the other end of said guide cylinder 40 is inserted into the recess 10d of the internal face surface of the cavity 10e. This guide cylinder 40 acts as a fixing member and holds the lock balls 46, which will be described later. A stepped-stopper part 40e is formed at the midpoint of the outer periphery of the guide cylinder 40 in the longitudinal direction by making the external diameter of the other end of the guide cylinder 40 larger. A long hole 40d, through which passes a release bar 41 that is affixed to a sliding frame 42, which is a component member of the unlocking mechanism described below, is formed at the midpoint of the other end of the guide cylinder 40.

The opening spring 51 uses coil spring whose two ends are free and that are inserted on the guide cylinder 40 in the case 10 so as to be positioned on the bump 49a side of the block 49, which is one side of the guide cylinder 40 positioned in the linear-movement direction of the transmission members 30 and 31.

A workpiece 50 is provided inside the cavity 10e of the case 10 between the opening spring 51 and the transmission members 30, 31 with said workpiece 50 being slidably inserted on the guide cylinder 40. One end of said workpiece 50 contacts both ends of the opening spring 51 and other end of said workpiece 50 can contact the transmission members 30 and 31. Accordingly, the workpiece 50 receives pressure from the opening spring 51 and, by moving in the direction opposite to the urging force of the opening spring 51, also stores release pressure for the opening spring 51 to generate door-release pressure. Moving force is also applied to the transmission members 30 and 31 via the workpiece 50. At the central part of the other end of the workpiece 50 there is formed a recess-shaped engaging sections 50b that engage the stopper parts 40e of the guide cylinder 40 and the lock balls 46.

The lock balls 46 are held inside a ball-holding holes 40c that are formed on the guide cylinder 40, and said lock balls 46 are movable in the radius direction of the guide cylinder 40. In this case, multiple (preferably three or more) lock balls 46 are held in the ball-holding holes 40c.

When the door 2 opens, the lock balls 46 move to the outer surface of the guide cylinder 40 and engage the engaging sections 50b of the workpiece 50, thereby locking the movement of the workpiece 50, and thus extension of the opening spring 51 is inhibited, and accordingly the opening spring 51 is locked in the release-pressure-storing state.

The work for thrusting the lock balls 46 into the ball-holding holes 40c of the guide cylinder 40 is provided for the workpiece 50. To achieve that, for example, there are formed, for example, either arcs (not shown) at the shoulder part of the engaging sections 50b of the workpiece 50, or slanted face parts (not shown) at the engaging sections 50b of the workpiece 50, either of which makes it possible for the workpiece 50 to easily thrust the lock balls 46 in the direction indicated by the guide cylinder 40.

An unlocking member 44 is inserted slidably into the guide cylinder 40 and along the inner surface 40a of said guide cylinder 40. A piston 44a, whose diameter is enlarged to become larger than that of the unlocking member 44, is formed on one end (on the side of the block 49) of the unlocking member 44, and this piston 44a is inserted slidably into the guide cylinder 40 and along the inner surface 40b, whose inside diameter is enlarged on one end (on the side of the block 49) of said guide cylinder 40.

A minor-diameter axis section 44b that is made smaller is formed at the midpoint of the other end (at the side of the transmission members 30 and 31) of the unlocking member 44, and a taper portion 44c is formed at a step part of one end (at the side of the block 49) of the minor-diameter axis section 44b.

A lock spring 45, which urges the unlocking member 44 to move in the direction of the transmission members 30 and 31, is provided between the piston 44a of the unlocking member 44 and the bump 49a of the block 49.

The above-described guide cylinder 40, the unlocking member 44, the lock spring 45, the lock balls 46, and the like constitute elements of the lock mechanism.

The cavity on the inner surface 40a of the guide cylinder 40 is sealed by O-rings 47 and 48 that are affixed on grooves formed on the inner surface 40a of the guide cylinder 40 and on the outer surface of the bump 49a of the block 49, respectively, and said cavity is filled with oil of the proper viscosity.

There is provided a narrow channel that links the inside of the cavity of the inner surface 40b of the guide cylinder 40 to the piston. This narrow channel, to be described further below, is provided so as to secure a damper function that slows the moving speed of the unlocking member 44 by providing the flow resistance of said oil accompanied by the movement of the piston 44a. Although proper clearance for said narrow channel might be provided between the inner surface 40b of the guide cylinder 40 and the outer surface of the piston 44a, this embodiment provides an orifice 44e on the piston 44a of the unlocking member 44.

Thus, the cavity of the inner surface 40b of the guide cylinder 40, the oil that is filled into the cavity, the inner surface 40b of the guide cylinder 40, the piston 44a of the unlocking member 44, the narrow channel or the orifice 44e provided between the inner surface 40b of the guide cylinder 40 and the piston, and the like constitute the elements of the damper mechanism that slows the moving speed of the unlocking member 44.

The sliding frame 42 is inserted slidably into and at the other end (on the side of the transmission members 30 and 31) of the guide cylinder 40 and along the inner surface 40a of said guide cylinder 40.

A release bar 41 that extends upward in the Figures is vertically provided in the middle portion of the sliding frame 42, and this release bar 41 penetrates the horizontal hollow 40d of said guide cylinder 40.

An unlock spring 43 is sandwiched between the sliding frame 42 and the unlocking member 44 so as to cause each of them to move in the respective direction that enables them to repel each other.

An engaging groove 30b on which to move the release bar 41 of the sliding frame 42 within a specified range is formed on the first transmission member 30, extending from one side (at the side of the workpiece 50) to the other side (left side in the Figures). Therefore, the release bar 41 is bent at its tip end so as to correspond to the eccentricity of the first transmission member 30 towards the sliding frame 42, as shown in FIG. 6.

The above-described release bar 41, the sliding frame 42, the unlock spring 43, the unlocking member 44, and the like constitute elements of the unlocking mechanism.

Said lock mechanism and unlocking mechanism, and the unlocking mechanism and the damper mechanism, act in relation to one another, as further described below, and accordingly they also constitute elements of an unlock-delaying mechanism that unlocks the workpiece in a delayed manner after the door 2 is totally closed.

The action of this embodiment will now be described step-by-step, referring to FIGS. 9 to 17, which are cross-sectional views along the line D-D of FIG. 6.

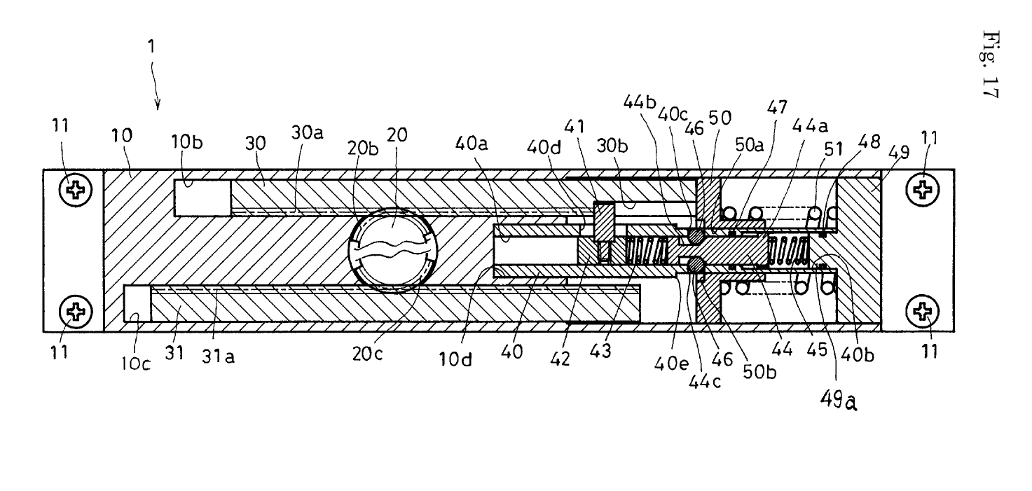

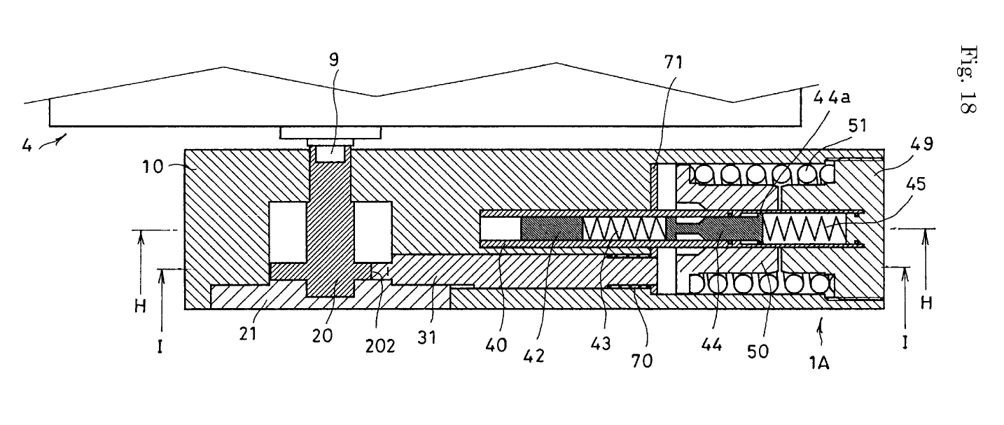

FIG. 9 shows the condition when the door-opening assisting device 1 urges the door 2 in the door-opening direction when the door 2 is totally closed. In this state, the surface of the engaging groove 30b of the first transmission member 30 engages (comes into contact with) the release bar 41, causing the sliding frame 42 to move backward, toward the right side in FIG. 9. At this time, the urging force of the unlock spring 43 becomes stronger than that of the lock spring 45, and therefore the unlocking member 44 is pressed and moved back by the urging force of the unlock spring 43, which is being pressed by the sliding frame 42. This enables the lock balls 46 to enter into the ball-holding holes 40c so as to contact the minor-diameter axis section 44b of the unlocking member 44. Accordingly, the workpiece 50 comes into a free state, i.e., in an unlocked state, and it presses the first transmission member 30 in the door-opening direction toward the right in the FIG. 9 (in the direction indicated by the arrow G in FIG. 10, as will be described later), receiving the urging force of the opening spring 51. Therefore, the transmission member 30 urges the passive member 20 to rotate counterclockwise, in the direction indicated by opening the door 2 (in the direction indicated by arrow F in FIG. 10, as will be described later). In this state, the door 2 is subject to the opening-direction force, but the door remains totally closed because the door is locked by a latch (not shown).

FIG. 10 shows the condition when the door 2 is opened within the door-opening-assisting area from the totally closed state, after the door 2 has been unlocked by the turning of the knob 8. As shown in FIG. 9, because the workpiece 50 comes into a free state (an unlocked state), receiving the urging force of the opening spring 51, the workpiece 50 moves the first transmission member 30 in the direction indicated by the arrow G (in FIG. 10) when the door 2 is unlocked. As just described, the opening of the door 2 causes the passive member 20 that is connected to the pinion shaft 9 of the closer 4 to rotate in the direction indicated by the arrow F (in FIG. 10), which allows the door 2 to be urged in the direction indicated by opening, via the pinion 9 of the door closer 4, which is connected to the passive member 20. This helps to reduce the operating force needed when the door is beginning to open, making it easy to open the door. As described above, the area where the opening spring 51 applies release pressure as a result of the movement of the first transmission member 30 when the portion gear 20b of the passive member 20 connects the transmission member 30a of the first transmission member 30 as a result of the rotation of the passive member halfway within the predetermined angle region when the door 2 begins to open, as will be described later, is called the door-opening-assisting area.

Accompanying the rotation of the passive member 20 in the direction indicated by the arrow F, the first and the second transmission members 30 and 31, which connect with the portion gears 20b and 20c, respectively, of the passive member 20, move in the direction indicated by G and H, respectively. As a result of the movement of the first transmission member 30 in the direction indicated by G, the release bar 41 and the sliding frame 42 move toward the left in the Figure, following the movement of the first transmission member 30, until they contact the end face of the elongated hole 40d of the guide cylinder 40 as a result of the urging force of the unlock spring 43. The urging force of the unlock spring 43 becomes increasingly weaker than that of the lock spring 45 as a result of the extension of the unlock spring 43 accompanying the movement of the sliding frame 42. However, the workpiece 50 moves toward the right in the direction indicated by G, accompanying the movement of the first transmission member, which enables the inner surface 50a to depress the lock balls 46, which prevents the lock balls 46 from protruding from the ball-holding holes 40c of the guide cylinder 40, and therefore the workpiece 50, which receives the urging force of the opening spring 51 smoothly moves left, pressing the first transmission member 30 to move in the direction indicated by G

As described above, the opening spring 51 finishes applying the release pressure after the first transmission member 30 moves when the portion gear 20b of the passive member 20 connects with the connecting portion 30a of the first transmission member 30 as a result of the rotation of the passive member halfway within the predetermined angle region when the door 2 begins to open. Approximately one-half of the predetermined angle region of said door 2 is set as the open angle (i.e., the door-opening-assisting area).

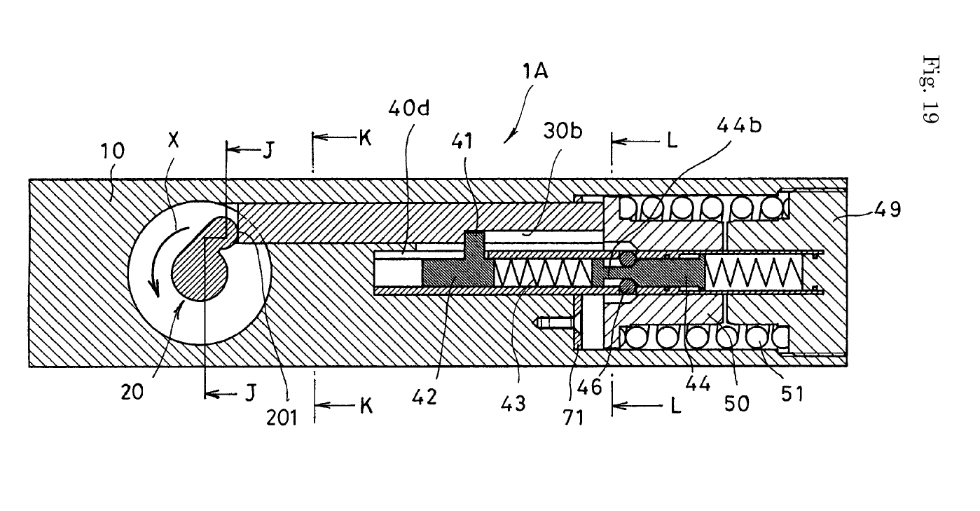

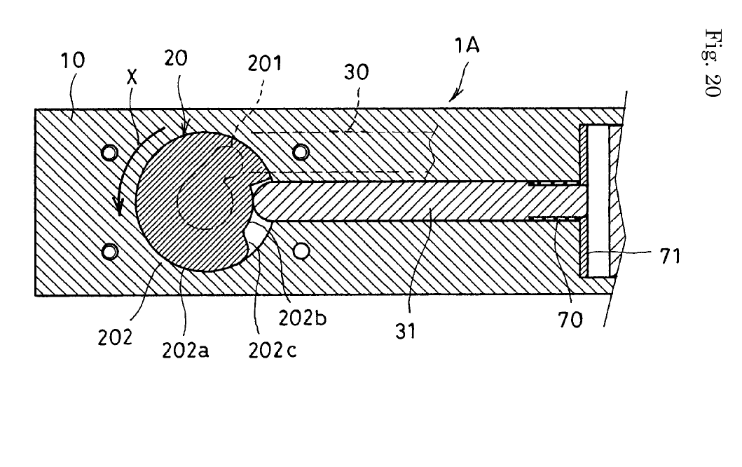

FIG. 11 shows the condition following that of FIG. 10, when the door is being opened to the ending position of the door-opening-assisting area and hence the opening spring 51 is starting to accumulate and store release pressure. The workpiece 50 moves further to the left and stops at the stepped-stopper part 40e of the guide cylinder 40. The opening of the door 2 causes the passive member 20 to rotate, via the pinion 9 of the door closer 4, in the direction indicated by F. This results in movement of the transmission members 30 and 31 in the directions of G and H, respectively, which causes the first transmission member 30 to separate from the workpiece 50 and causes the second transmission member 31 to move toward and to contact the workpiece 50, moving the workpiece 50 to the right. Along with the movement of the workpiece 50, the opening spring 51 is moved so as to compress itself in the direction opposite to the urging direction (to the right in FIG. 11), and release pressure starts to be accumulated in the direction to open the door 2.

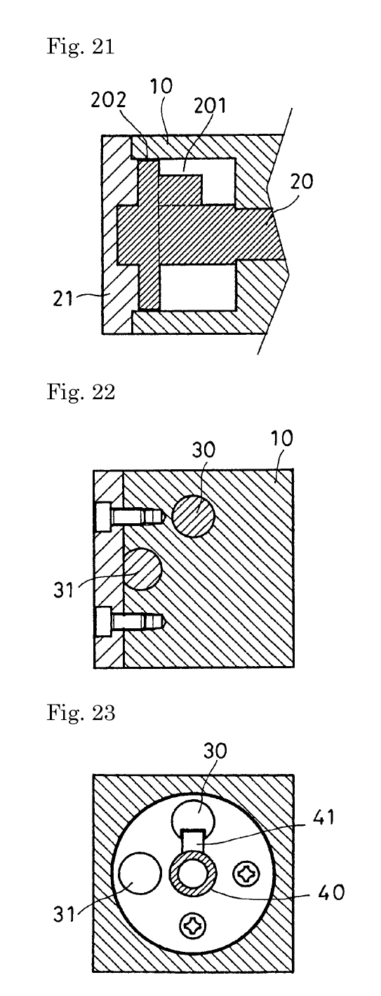

FIG. 12 shows the condition after release pressure has been completely accumulated in the opening spring 51. The rotation of the pinion 9 of the closer 4, and the passive member 20 that is connected to the pinion 9 in the direction indicated by F causes the second transmission member 31 to move in the direction indicated by H, pushing the workpiece 50 to the right to the original position, and thus the action to accumulate and store release pressure in the opening spring 51 ends. The door 2 is at the end-point of what is the predetermined angle region when the door is beginning to open, with said predetermined angle set at a degree that does not allow the door to open enough to allow a person to pass through the doorway.

As described above, when the door is beginning to open, because the predetermined angle region is set at a degree that does not allow the door to open enough to allow a person to pass through the doorway, the opening spring 51 can open the door 2 easily due to the releasing of door-opening pressure within the door-opening-assisting area for one-half of the predetermined angle, and can accumulate release pressure in succession when the door opens to the end-point of the predetermined angle region. In other words, before the door is opened enough to allow a person to pass through the doorway, two actions—the releasing of door-opening pressure and the storing of door-release pressure—of the opening spring 51 can be completed in succession. Consequently, if, for example, the door 2 starts to be opened but then is closed before it is fully opened, there is no malfunction such as failing to accumulate and store release pressure of the opening spring 51.

FIG. 13 (a) shows the opening spring 51 in a locked state after it has completed its accumulation of release pressure; FIG. 13 (b) shows the condition when the first transmission member 31 is connected with the portion gear 20b of the passive member 20 at that time; and FIG. 13 (c) shows the condition when the second transmission member 31 is connected with another portion gear 20c of the passive member 20 at that time. When the workpiece 50 returns to its original position by moving in reverse to the right, the holding of the lock balls 46 inside of the ball-holding holes 40c by the inner face 50a of the workpiece 50 ends, and the unlocking member 44 moves to the right by the urging force of the lock spring 45 because the urging force of the unlock spring 43 has already become weaker than that of the lock spring 45. This movement of the unlocking member 44 pushes the lock balls 46 out of the ball-holding holes 40c of the guide cylinder 40 to the outer surface of the unlocking member 44, where they engage with the engaging sections 50b of workpiece 50, and therefore the movement of the workpiece 50 to the left is stopped, and the opening spring 51 is locked while storing release pressure.

Accordingly, in this embodiment, it is possible to store in the opening spring 51—within approximately the latter half angle of the predetermined angle when the door 2 begins to open—release pressure to urge the door 2 in the opening direction.

FIG. 14 (a) shows the condition when the door 2 is further opened from the condition of FIG. 13; FIG. 14 (b) shows the state of disengagement of the first transmission member 30 from the portion gear 20b of the passive member 20 at that time; and FIG. 14 (c) shows the state of disengagement of the second transmission member 31 from the other portion gear 20c of the passive member 20 at that time. Portion gears 20b and 20c of the passive member 20 that are connected with the first and the second transmission members 30 and 31 rotate until the final position of the connecting portion (which corresponds to the final position of the predetermined angle when the door begins to open), and the first and the second transmission members 30 and 31 remain stationary without moving subsequently if the passive member 20 rotates in the direction indicated by F by opening the door 2. Accordingly, after the portion gears reach the final position of the predetermined angle area, when the door-opening torque is stored, resistance other than force of the door closer 4 will not be applied against the door 2 if the door 2 is opened.

FIG. 15 shows the condition, when the door 2 is almost totally closed. The closing of the door 2 is automatically done as a result of the urging force of the coil spring 4e and the pinion 9 rotates in the direction to close the door 2. This allows the passive member 20 to rotate in sync with the pinion 9 of the door closer 4 in the direction indicated by the arrow I. The first and the second transmission members 30 and 31 move in the directions indicated by the arrows J and K, respectively, as a result of the rotation of the passive member 20 in the direction indicated by the arrow I. The left-end surface of the engaging groove 30b of the first transmission member 30 contacts the release bar 41 when the first transmission member 30 moves in the direction indicated by J, during which time the unlock spring 43 is being compressed by moving to the right the release bar 41 and the sliding frame 42 that locks the release bar 41.

FIG. 16 shows the previous condition when the lock of a lock mechanism starts to be unlocked at the moment when the door 2 is totally closed. One end (the right side in FIG. 16) of the transmission member 30 contacts the workpiece 50. At the same time, the unlock spring 43 is fully compressed by the sliding frame 42, and the urging force of the unlock spring 43 becomes stronger than that of the lock spring 45. The unlocking member 44 is then moves to the right as a result of being pressed by the unlock spring 43. The unlocking member 44 moves at a reduced speed as a result of the damping effect caused by the flow resistance provided by the oil in the orifice 44a, because the cavity of the inner surface 40b of the guide cylinder 40 is filled with viscous oil. Accordingly, the lock mechanism starts to be unlocked at the moment when the door 2 is totally closed, but the workpiece 50 is still locked in the engaging state where the lock balls 46 contact the engaging sections 50b of the workpiece 50. That is to say, the unlock-delaying mechanism, consisting of said lock mechanism, the unlocking mechanism and the damper mechanism that perform such collaborative action, operates at the same time when the door 2 is totally closed.

The condition succeeding the condition shown in FIG. 16 is shown by FIG. 17, which shows the condition when the lock of the lock mechanism is unlocked after the door 2 is totally closed. As a result of the movement of the unlocking member 44 to the right (in FIG. 17), the lock balls 46 drop to the minor-diameter axis section 44b of the unlocking member 44, which is a lock-release position, and the unlocking condition shown in FIG. 9. The unlocking action accompanying such movement of the unlocking member 44 to the right is made slowly as a result of the aforementioned damping effect, and therefore there is a time differential from when the door 2 is totally closed and said unlocking, and accordingly the lock is not released until the door 2 is totally closed and locked. That is to say, the movement of the workpiece 50 is successively locked by the lock balls 46 until the door 2 is totally closed and locked, and therefore the opening spring 51 continues to store release pressure, and said pressure will not act in the door-opening direction. In this locking condition, the door 2 is totally closed, with the lock being released later, and it is not until the state shown by FIG. 9 is recovered that the locking is reversed and the door 2 is urged in the opening direction. This will not generate resistance in the door-opening direction at the moment of total closure of the door 2, and therefore the door 2 can be locked unfailingly.

In this kind of embodiment, the door 2 is constantly urged in the opening direction when the door 2 is closed, and therefore the operating force when the door is beginning to open is reduced by the unlocking of the door 2. Moreover, the operation for reducing the operating force is automatically made by the total closure of the door 2, and therefore operation of the other members in order to reduce the operating force as is traditionally done is not necessary, resulting in the improvement of the operability of the door-opening assisting device. In addition, the case 10 is mounted on the door closer 4, and therefore there is no need for disposing the door-opening assisting device 1 in such other places as on the door 2 or on the wall 3. Accordingly, the passage of people through the doorway is not obstructed, and degradation of the appearance of the door is prevented.

In this embodiment, the pair of portion gears 20b and 20c of the passive member 20 is shown as having the same size and having the same gear ratios with the first and second transmission members 30 and 31, even if that is not stated explicitly. In particular, by increasing the gear ratio with the second transmission member 31 by forming one portion gear 20c to have a smaller minor diameter than the other portion gear 20b, for instance, it is also possible to reduce the operating force needed for opening the door when the door-release pressure has been stored.

FIGS. 18 to 23 show the door-opening assisting device 1A of the second embodiment of the present invention. The same alphanumeric characters used in regard to the first embodiment are assigned to the corresponding members of the second embodiment.

In this embodiment, as shown in FIGS. 19 and 20, the first cam face 201 and the second cam face 202 are formed on the passive member 20 that is connected to the pinion 9 of the door closer 4; the first transmission member 30 contacts the first cam face 201; and the second transmission member 31 contacts the second cam face 202. These transmission members 30 and 31, which are orthogonally provided centering on the guide cylinder 40 that has been inserted into the case 10 as shown in FIG. 23, independently move forward and backwards in the rectilinear direction inside the case 10.

Also in this embodiment, the guide cylinder 40 is provided as a fixing member by being inserted into the case 10, and the sliding frame 42, the unlock spring 43, the unlocking member 44, and the lock spring 45 are provided in the longitudinal direction inside the guide cylinder 40. Also, the workpiece 50 is inserted on the guide cylinder 40, and the opening spring 51 is provided outside of the workpiece 50. Moreover, there is provided lock balls that engage and disengage with the workpiece 50 as a result of the sliding of the unlocking member 44. The sliding frame 42, the unlock spring 43, the unlocking member 44, the lock spring 45, the workpiece 50, the opening spring 51, and the lock balls 46 are not described here, because they act in the same way as their corresponding parts in the first embodiment, shown in FIGS. 1 to 17. In addition, the damper mechanism is provided by filling oil inside the cavity of the unlocking member 44 and also forming a narrow channel between this cavity and the piston 44a.

A first cam face 201 of the passive member 20 is formed on the arc face that is formed in the radius direction and apart from the center of rotation of the passive member 20, as shown in FIG. 19. When this first cam face 201 comes into contact with the first transmission member 30 that moves when the door 2 begins to open, the first cam face 201 receives the movement of the first transmission member 30, and accordingly the first transmission member 30 moves to the left (in FIG. 19) as a result of the release pressure stored in the opening spring 51, thereby rotating the passive member 20 in the opening direction (in the direction indicated by the arrow X in FIGS. 19 and 20), which allows the operating force when the door is beginning to open to be reduced. Meanwhile, the first transmission member 30 is moved because of being pressed by the opening spring 51. When the workpiece 50 contacts the keep plate 7 and then stops, the first transmission member 30 will not move further and also stops. In contrast, however, the continuation of the opening of the door 2 causes the passive member 20 to rotate in the opening direction of the door 2 (in the direction indicated by the arrow X).

A second cam face 202 is formed of a circular face 202a as the outer shape of the passive member 20 and a concave surface 202b made by a partially hollowing of the circular face 202a, as shown FIG. 20. The concave surface 202b has a connecting surface 202c that is connected to the circular face 202a. The connecting surface 202c contacts the second transmission member 31 at the moment when that transmission member has moved to the maximum extent possible, and in this state of contact the passive member 20 rotates in the door-opening direction (in the direction indicated by the arrow X), which moves the transmission member 31 in the direction indicated by pressing it (to the right in FIG. 20). Meanwhile, the top of the second transmission member 31 is formed in arc shape in order to make said second transmission member 31 slide smoothly, the sliding being caused by said second transmission member 31 coming into contact with the second cam face 202.

As shown in FIGS. 18 and 20, a return spring 70 is provided at the end of the second transmission member 31 that is opposite to the passive member 20 between the transmission member 31 and the case 10, and said return spring 70 is prevented from dropping out by the spring-retention plate 71. The return spring 70 urges the second transmission member 31 to move toward and to contact the second cam face 202.

Also in the above arrangement, when the door 2 is totally closed, the workpiece 50 is urged by the opening spring 51 and is in an unlocked state. Therefore, when the door 2 is opened by reversing the locking, the workpiece 50 moves to the left (in the door-opening direction) and moves the first transmission member 30 in the same direction. The first transmission member 30 presses the first cam face 201, and therefore the passive member 20 rotates in the door-opening direction (in the direction indicated by the arrow X). Accordingly, this allows the door 2 at the beginning of opening (door-opening-assisting area) to open by reduced force.

The workpiece 50 contacts the case 10, and the first transmission member 30 stops after it has moved to the maximum extent possible. At the same time, the concave surface 202b of the second cam face 202 of the passive member 20 contacts the second transmission member 31. Moreover, as a result of the continuation of the opening of the door 2, the connecting surface 202c of the second cam face 202 approaches and contacts the second transmission member 31 and moves that same member 31 to the right. This causes the workpiece 50 to move to the right and to compress the opening spring 51, as a result of which the opening spring 51 accumulates release pressure. The operation of the opening spring 51 until the accumulation of storing release pressure is complete is the same as with the first embodiment, with the workpiece 50 being locked and then the opening spring 51 being locked in the release-pressure-storing state after the lock balls 46 enter into and engage with the workpiece 50. Accordingly, also in this embodiment, it is possible to store in the opening spring 51—within approximately the latter half angle of the predetermined angle when the door 2 begins to open—release pressure to urge the door 2 in the opening direction.

When the door 2 is further opened to the extent that people can pass through the doorway, the second cam face 202 of the passive member 20 rotates while the circular face 202 contacts the second transmission member 31, and therefore the second transmission member 31 will not move further. Accordingly, after the final position of the predetermined angle where the release pressure of the door 2 is stored is reached, no resistance other than force of the door closer 4 will be applied against the door 2 if the door 2 is opened.

After that, the closing operation, by which the door 2 is closed to the previous condition of being totally closed, is automatically made by urging force of the coil spring 4e of the door closer 4, and the pinion 9 rotates in the door-closing direction of the door 2. This causes the passive member 20 to rotate in the direction opposite to that indicated by the arrow X. By this rotation: the first cam face 201 moves the first transmission member 30 to the right; the sliding frame 42 moves in the same direction, compressing the unlock spring 43; the unlocking member 44 moves in the same direction; the lock balls 46 disengage from the workpiece 50; and the locking of the workpiece 50 is reversed accordingly. This operation is the same as that of the first embodiment. This unlocking is also delayed by the damper mechanism after the door 2 is totally closed, and this operation also is the same as that of the first embodiment. As described above, when the door 2 is totally closed, the workpiece 50 is urged so as to move in the door-opening direction as a result of the opening spring 51, which is storing release pressure, allowing the operating force when the door 2 is beginning to open to be reduced.

Also in this embodiment, as described above, the operating force needed when the door 2 begins to open can be reduced, and such reduction of the operating force needed is made automatically just by closing the door 2 totally. Therefore the operation of other members in order to reduce the needed operating force is not necessary, resulting in improved operability. In addition, the case 10 is mounted on the door closer 4, and therefore there is no need for disposing the door-opening assisting device 1A on such other place as the door 2 or the wall 3, and accordingly the passage of people through the doorway is not obstructed, and degradation of the appearance of the door is prevented. In particular, this embodiment allows the first and the second transmission members 30 and 31 simply to contact the passive member 20 via a cam face and then to operate them, which provides the advantage of assuring operations at the beginning of switching and stopping of the operating members 30 and 31 than the gears that require connecting according to the first embodiment do.

The invention can be modified in various ways, and hence it is not limited to the above-described embodiments. For example, although in this embodiment door-opening assistance is enabled by mounting the case 10 on door closer 4, it is possible to integrally incorporate a pair of transmission members 30 and 31, the opening spring 51, the workpiece 50, and other component members inside the door closer 4 while eliminating the case 10. This would allow the door closer 4 and the door-opening assisting device to be simultaneously installed on the door 2, increasing the ease of installation.

### INDUSTRIAL APPLICABILITY

The door-opening assisting device of the above-described invention has a simple structure, eliminating the need for operating members other than an ordinary doorknob for opening and closing the door, for an expensive electromagnetic control system, and for an electric drive mechanism like the aforementioned existing door-opening assisting device, and this device also realizes high economic efficiency. In addition, the passive members that connect to the pair of transmission members are provided as two separated portion gears, and thus the two actions that allow the opening spring 51 to generate and to accumulate door-release pressure can be completed successively before the door is opened to the extent that people can pass through the doorway. Moreover, an unlock-delaying mechanism opens the lock that is held in the state of storing door-release pressure after the door is totally closed, and then release pressure for opening the door is applied after the door is closed and locked completely. This provides a door-opening assisting device that increases the reliability and operability of door opening and door closing, and makes the device compact and less conspicuous, preventing the deterioration of the appearance of the door. Furthermore, the door-opening assisting device of this invention can later be mounted on a standard door closer by minor work such as installing a passive member and a case, and such a device can be coupled with a door closer. Accordingly, this invention is especially well-suited for doors of both newly and already built condominiums and buildings that have airtight construction.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A door-opening assisting device, comprising:
a passive member connected to a door closer is configured to urge the door to move in the closing direction and to rotates forward and backwards in response to the opening and closing, respectively, of the door,
transmission members to move forward and backwards in the direction indicated by opening and closing, respectively, of the door, and
an opening spring urges the transmission members to move in the same direction indicated by an opening of the door, and which is locked in a release-pressure-storing state after accumulating and storing the release pressure that results from the movement of the transmission members, and wherein:
the rotation of the passive member within the predetermined angle region when the door is beginning to open, cause the opening spring applies the release pressure and then is locked in the release-pressure-storing state after storing release pressure.

2. A door-opening assisting device comprising:
a passive member that is connected to a door closer that urges the door to move in the door-closing direction, and that rotates forward and backwards in response to the opening and closing, respectively, of the door;
a transmission member that moves forward and backwards in the direction indicated by the opening and closing, respectively, of the door when the transmission member is connected with the passive member,
an opening spring that urges said transmission member to move the same in the door-opening direction when the door opens, and that accumulates and then stores door-opening release pressure as a result of the movement of the transmission member,
a lock mechanism that locks the opening spring in the release-pressure-storing state in response to the opening of the door, and
an unlocking member that unlocks the lock mechanism in response to the closing of the door, and wherein:
the passive member has a connecting portion on a part of the passive member's outer surface, and
the connecting portion connects with the transmission member in such a way that the opening spring is caused to apply release pressure due to the rotation of the passive member within the predetermined angle region when the door is beginning to open, to continuously accumulate and store release pressure, and to be locked in the release-pressure-storing state.

3. A door-opening assisting device comprising:
a passive member that is connected to a door closer that urges the door to move in the door-closing direction, and that rotates forward and backwards in response to the opening and closing, respectively, of the door,
a transmission member that, when connected with the passive member, moves forward and backwards in the direction indicated by the opening and closing, respectively, of the door,
an opening spring that urges the transmission member to move the same in the door-opening direction when the door opens, and that accumulates and stores door-opening release pressure as a result of the movement of the transmission member,
a fixing member that, in order to remain fixed at a home position, stretches in the direction indicated by the movement of the transmission member,
a workpiece that is provided between the opening spring and the transmission member in such a way that it can receive the opening spring's force and to move along the fixing member, applying force from the transmission member,
a lock mechanism that is supported by the fixing member and that has lock balls that, as a result of the opening of the door, lock the movement of the workpiece and thus locks the opening spring in the release-pressure-storing state, and
an unlocking member that, as a result of the closing of the door, unlocks the workpiece, and wherein:
the passive member has a connecting portion on its outer surface, and
the connecting portion of the passive member connects with the transmission member in such a way that the opening spring is caused to apply release pressure as a result of the rotation of the passive member within the predetermined angle region when the door is beginning to open, to continuously accumulate and store release pressure, and to be locked in the release-pressure-storing state.

4. A door-opening assisting device, comprising:
a passive member that is connected to a door closer that urges the door to move in the door-closing direction, and that rotates forward and backwards in response to the opening and closing, respectively, of the door,
a transmission member contactable with the passive member and that moves forward and backwards in the door-opening direction and door-closing direction, respectively, accompanying the rotation of the passive member,
an opening spring that urges said transmission member to move the same in the door-opening direction when the door opens, and that, as a result of the movement of the transmission member, accumulates and stores door-opening release pressure,
a lock mechanism that, when the door opens, locks the opening spring in the release-pressure-storing state, and
an unlocking member that, due to the closing of the door, unlocks the lock mechanism, and wherein:
the passive member has a cam face that contacts the transmission member, and
the cam face is formed so as to allow the opening spring to apply release pressure due to the rotation of the passive member within the area of the predetermined angle at the beginning of door opening and so as to allow the opening spring to apply release pressure, to accumulate and store release pressure, and to be locked in the release-pressure-storing state.

5. A door-opening assisting device comprising:
a passive member that is connected to a door closer that urges the door to move in the door-closing direction, and that rotates forward and backwards as a result of the opening and closing, respectively, of the door,
a transmission member that can contact the passive member and that moves forward and backwards in the door-opening direction and door-closing direction, respectively, accompanying the rotation of the passive member,
an opening spring that urges said transmission member to move the same in the door-opening direction when the door opens, and that, as a result of that movement of the transmission member, accumulates and stores release pressure in the door-opening direction,
a fixing member that, in order to remain fixed at a home position, stretches in the direction of movement of the transmission member,
a workpiece that is provided between the opening spring and the transmission member in such a way that it can receive the opening spring's moving force and move along the fixing member, applying moving force from the transmission member,
a lock mechanism that is supported by the fixing member and that has lock balls that, as a result of the opening of the door, lock the movement of the workpiece and thus lock the opening spring in the release-pressure-storing state, and
an unlocking member that, due to the closing of the door, unlocks the workpiece, and wherein
the passive member has a cam face that contacts the transmission member, and
the cam face allows the opening spring to apply release pressure due to the rotation of the passive member within the predetermined angle region when the door is beginning to open, to accumulate and store release pressure, and to be locked in the release-pressure-storing state.

6. A door-opening assisting device according to claim 2, wherein an unlock-delaying mechanism which is disposed between the lock mechanism and the unlocking member an unlock-delaying mechanism, is configured so that the workpiece is unlocked with a display after the door is totally closed.

7. A door-opening assisting device according to claim 6, wherein the unlock-delaying mechanism includes at least:
a lock spring that urges said unlocking member in the locking direction,
an unlock spring that urges the unlocking member in the direction opposite to the direction to which the lock spring urges the unlocking member, and
a damper mechanism that is mounted on one side of the unlocking member, and that slows the back and forth movement of the unlocking member.

8. A door-opening assisting device according to claim 7, wherein the damper mechanism includes:
a cylindrical cavity that extends along one side of the unlocking member and that contains oil,
a piston that is mounted on one side of the unlocking member, and is inserted into the cavity and slides along the inner wall of the cavity, and
a narrow channel that links the inside of the cavity and the piston.

9. A door-opening assisting device according to claim 2, wherein:
the transmission member is provided in pairs in a way that can independently move forward and backwards, and
each of the connecting portions of said passive member is formed separately in a way that enables it to connect with its corresponding transmission member.

10. A door-opening assisting device according to claim 2, wherein the passive member is a pinion gear, and the transmission member is a rack.

11. A door-opening assisting device according to claim 4, wherein:
the transmission member includes a first transmission member and a second transmission member that independently move forward and backwards, and
the cam face comprises:
a first cam face that receives the movement of the first transmission member that moves back to the state when the door begins to open, caused by the release pressure of the opening spring, and
a second cam face that moves the second transmission member in the direction where the opening spring accumulates and stores release pressure when the door begins to open in succession of the movement of the first transmission member.

12. A door-opening assisting device according to claim 11, wherein a return spring urges the second transmission member to contact the second cam face.
